(19) United States
(12) Patent Application Publication
(10) Pub. No.: US 2003/0090081 A1
(43) Pub. Date: May 15, 2003

(54) Passenger ingress and egress system for transit vehicle

(76) Inventor: Robert L. Oakley, LeClaire Chicago, IL (US)

Correspondence Address: JAMES RAY & ASSOCIATES, 2640 Pitcairn Road, Monroeville, PA, 15146, US

(21) Appl. No.: 10/290,821

(22) Filed: Nov. 8, 2002

Related U.S. Application Data
(60) Provisional application No. 60/336,777, filed on Nov. 12, 2001.

(51) Int. Cl. B60R 3/00

(52) U.S. Cl. 280/166

(57) ABSTRACT

A passenger ingress and egress system within a transit vehicle employing a movable step apparatus in combination with sliding type door system to accommodate variations in passenger ingress and egress platform facilities. Said movable step apparatus having at least three step members movable from a conventional step relation to permit ingress and egress from and onto a street platform to an aligned, coplanar relation to permit ingress and egress from and onto a commuter platform, generally located 50 inches above the Top Of Rail. A gap reduction apparatus is disposed within the movable step apparatus to minimize horizontal distance between a commuter platform and the movable step apparatus with all step members in an aligned, coplanar relation to meet federal regulations for American with Disability Act.

### CROSS-REFERENCE TO RELATED APPLICATIONS

This application is related to and claims priority from U.S. Provisional Patent Application Serial No. 60/336,777 filed on Nov. 12, 2001. This application is also related to the invention disclosed in U.S. Pat. No. 3,957,284 titled “Movable steps for transit vehicle”. The teachings of U.S. Pat. No. 3,957,284 are incorporated into this document by reference thereto.

### FIELD OF THE INVENTION

The present invention relates to a transit vehicle utilizing a combination of a sliding door system with a movable step apparatus disposed adjacently said sliding door system and a gap reduction apparatus disposed within said movable step apparatus for accommodating varying platform conditions of passenger ingress and egress.

### BACKGROUND OF THE INVENTION

Three different platform conditions exist in passenger ingress and egress onto and from passenger transit vehicle. The first condition relates to the passenger ingress and egress from and onto a platform which is about 8 inches above top of rail (TOR). Said platform is hereinafter referred to as a street platform. The second condition relates to the passenger ingress and egress from and onto a platform which is about 34 inches above TOR. Said platform is hereinafter referred to as a subway platform. The third condition relates to the passenger ingress and egress from and onto a platform which is about 50 inches above TOR. Said platform is hereinafter referred to as a commuter platform. Both the subway and commuter platform heights correspond to the height of the vehicular floor surface above Top of rail.

Typically, a transit vehicle interfaces with only one type of the platform, however, special cases exist where said transit vehicle must be adapted to interface with more than one platform type and, more particularly, interface with a street platform and either a subway or commuter platform. In such case, the transit vehicle must incorporate means compensating for different platform height above TOR.

One approach to accommodate varying platform types and, more particularly, a combination of commuter and street platforms is to incorporate a passenger ingress and egress system including a stationary stairwell disposed within floor surface in combination with a stairwell platform pivotally connected to one side of an upper horizontal plane of the stairwell and manually displaceable to lie in the horizontal plane over the stairwell for accommodating commuter platforms. This approach requires manual operation of said stairwell platform thus increasing operational costs due to necessity of having personnel to position said stairwell platform in the appropriate plane and also increases a dwell time at the station to reconfigure said stairwell platform orientation.

Another approach is to incorporate a passenger ingress and egress system including movable stairwell platform in combination with a complex door construction consisting of a door lower member movably connected to an upper door member. The lower door member is for covering the stairwell opening for passenger loading from a subway or commuter platform.

Yet another approach is to employ a movable step apparatus as disclosed in the U.S. Pat. No. 3,957,284. Such movable step apparatus includes a first and second steps being movable by a pneumatic drive member from a conventional relation enabling ingress and egress from and onto street platform to an aligned coplanar position creating an extension of the floor surface and, more importantly, enabling ingress and egress from and onto the subway platform. The teachings of U.S. Pat. No. 3,957,284 Movable Steps for transit vehicle are hereby incorporated into the present application by reference thereto. Said movable steps have been incorporated into a stairwell structure of a transit vehicle adjacent to a plug type door system disposed within a door portal aperture and having at least one door disposed substantially flush with the side wall of said transit vehicle in the closed position and first moving outward and then moving longitudinally, along the outer wall of said transit vehicle during opening.

It has been generally accepted that for passenger safety each step within a stairwell or movable step apparatus should be approximately 10 inches wide and the vertical displacement between each step or the step and street platform should be in the range from 9 inches to 11 inches.

The primary limitation of the invention disclosed in U.S. Pat. No. 3,957,284 lies in that it only accommodates the combination of street platform and subway platform. A further limitation of the invention lies in that it does not meet Federal Regulation regarding Americans with Disabilities Act (ADA) requirement that the horizontal displacement, generally referred to as the gap, between the subway or commuter platform edge and inner floor structure of the transit vehicle, with its doors open, can not exceed 3 inches. Due to the gap (or clearance) between the edge of the platform and the outer surface of the transit vehicle being approximately 3 inches and due to the door construction typically between 1 inch to 2 inches wide and required clearance with the inner surface of the door, the outer edge of the step apparatus is approximately between 4.5 inches and 5.5 inches away from the edge of the subway platform with the doors in fully open position.

Subsequently, a gap reduction apparatus has been added to such movable step apparatus to meet the maximum allowable gap of 3 inches. Such apparatus having a movable member for extending into the space occupied by said at least one door upon said at least one door first moving outwardly. In such arrangement, the gap between the platform and the step apparatus is reduced prior to the door moving longitudinally and beginning to uncover the door portal opening. This arrangement allows for passenger ingress and egress while meeting the requirements set forth by ADA.

It is well known in the art that pocket sliding type door systems are less complex than the plug type door system and therefore are being predominantly utilized in transit vehicles and, more particularly, are being predominantly utilized in transit vehicles interfacing with commuter and street type platforms and presently employing manually operated means for accommodating ingress and egress from and onto said commuter platform while utilizing stairwell for ingress and egress from and onto a street platform. This type of door system including at least one door movable between the inner and outer wall members of the transit vehicle for at least partially covering and uncovering a door portal opening. However, the disadvantage of the pocket sliding door system lies in that the presence of the outer wall member increases the horizontal gap to be reduced. Given the gap (or clearance) between the edge of the platform and the outer surface of the transit vehicle being approximately 3 inches, outer wall member is typically between 1.5 inches and 2 inches and door construction typically between 1 inch to 1.5 inches wide, the total horizontal gap to be overcome is approximately between 5.5 inches and 6.5 inches. Additional disadvantage in overcoming the gap lies in that the side vehicular structure curves or slops toward the underside structure of the vehicle creating an even larger distance to the stationery platform.

As it can be seen from the above discussion there is a need to improve cost and efficiency of transit vehicle operation utilizing sliding pocket type door systems and accommodating street and commuter platforms while meeting various safety requirements.

### SUMMARY OF THE INVENTION

The present invention provides a passenger ingress and egress system disposed within a transit vehicle for accommodating a street platform and further accommodating a commuter platform. Such passenger ingress and egress system comprises a sliding pocket door disposed within a door portal cavity. Such passenger ingress and egress system further comprises a movable step apparatus disposed within a stairwell cavity further disposed within a floor surface.

Such movable step apparatus is comprised of a frame, an inner step member, operatively mounted to said frame, said step member having a horizontally disposed upper surface at a first elevation, a middle step member operatively mounted to said frame, said second step member having a horizontally disposed upper surface at a second elevation, lower than said first elevation and an outer step member, operatively mounted to said frame, said step member having a horizontally disposed upper surface at a third elevation, lower than the said second elevation. A pneumatic drive mechanism is provided for raising said step members vertically to a fourth elevation coplanar with the floor surface while maintaining the upper surface of said raised step member in a horizontal position. Linkage means are also provided connecting said step members and being responsive to the raising of the step member for elevating the other of said step members vertically to the forth elevation while maintaining the upper surface of said step member in a horizontal position so that the upper surfaces of said step members are disposed in the same plane at the forth elevation.

A gap reduction apparatus having a horizontally disposed upper surface is connected to an outer step member and driven in a substantially horizontal directions by a gap reduction drive mechanism to minimize the distance between said outer step member and commuter platform when all step members are substantially coplanar with the floor surface of the transit vehicle.

### OBJECTS OF THE INVENTION

It is therefore one of the primary objects of the present invention is to provide a means for accommodating passenger ingress and egress from and onto a street platform of 8 inches above Top Of Rail and a commuter platform of 50 inches above Top Of Rail.

A further object of the present invention is to provide a means for accommodating passenger ingress and egress from and onto a street platform of 8 inches above Top Of Rail and a commuter platform of 50 inches above Top Of Rail in combination with a sliding type door system.

Additional object of the present invention is to provide a means for accommodating passenger ingress and egress from and onto a street platform of 8 inches above Top Of Rail and a commuter platform of 50 inches above Top Of Rail which meets applicable regulatory requirements.

Another object of this invention is to provide a means for accommodating passenger ingress and egress from and onto a street platform of 8 inches above Top Of Rail and a commuter platform of 50 inches above Top Of Rail which does not require manual intervention.

Yet another object of the present invention is to provide means for accommodating passenger ingress and egress from and onto a street platform of 8 inches above Top Of Rail and a commuter platform of 50 inches above Top Of Rail employing a simple one-piece door construction.

These and various other objects and advantages to the present invention will become more apparent to those persons skilled in the art from the following more detailed description, particularly, when such description is taken in conjunction with the attached drawings and the appended claims.

### BRIEF DESCRIPTION OF THE DRAWINGS

FIG. 1 is a partial horizontal cross sectional view of a doorway of a mass transit vehicle showing doors in the closed position and gap reduction member in the partially extended position.

FIG. 2 is a partial horizontal cross sectional view of a doorway of a mass transit vehicle showing doors in the open position and gap reduction member in the fully extended position.

FIG. 3 is a vertical cross sectional view of the step members with a portion broken away to show the linkage means, the step members being in a substantially lowered position.

FIG. 4 is a vertical cross sectional view of the step members being in a substantially raised position, with the portion broken away to show platform gap reduction member.

FIG. 5 is a frontal elevation view of the drive mechanism shown through cut-away views with step members being in a substantially lowered position.

### DESCRIPTION OF THE PREFERRED EMBODIMENTS

Prior to proceeding to the more detailed description of the present invention, it should be noted that for the sake of clarity identical components, having identical functions have been identified with identical reference numerals throughout the several views which have been illustrated in the drawing figures.

The invention disclosed herein largely overcomes the above discussed difficulties through the use of the movable step apparatus having at least three step members to comply with the regulations regarding the vertical displacement between each step member for ingress and egress of passengers from and onto a street platform. At least one gap reduction member is employed to minimize the substantially horizontal displacement between the commuter platform and movable step apparatus having all step members in a substantially raised coplanar position. During the substantially vertical movement of all step members to the second raised position the gap reduction member first moves partially to a third position and then moves further to a forth position into the door portal aperture providing for a greatly simplified door construction comprising of one-piece member. Said two step method of the gap reduction allows first to overcome the curvature or slope of the outer side vehicular structure and substantially reduce the gap between the outer step member and the at least one door during said outer step member movement in the substantially vertical direction. The design, therefore, provides advantage of reduced manufacturing and operational costs while meeting the regulatory requirements.

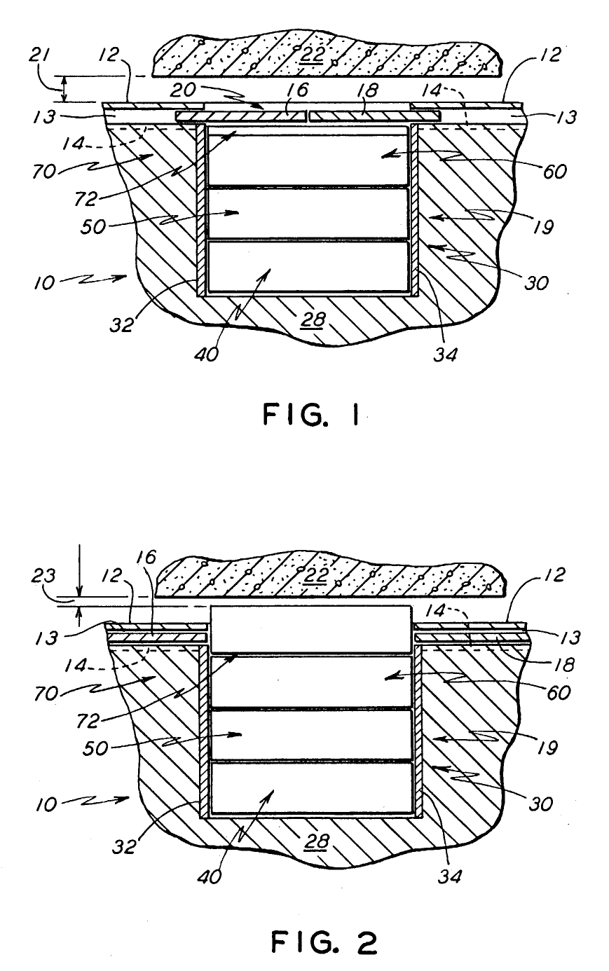

With reference to FIG. 1 of the present embodiment, transit vehicle 10 is illustrated having an outer wall 12 and inner wall 14 enclosing a door cavity 13. Door portal aperture, generally designated 20, having a first door 16 and a second door 18 is located adjacent to stairwell, generally designated 19. First door 16 and second door 18 are movable in a substantially linear path and are shown in a substantially closed position. Movable step apparatus, generally designated 30, comprising an inner step member, generally designated 40, a middle step member, generally designated 50, an outer step member, generally designated 60 is located within the stairwell cavity 19 and enclosed within first and second side frame members 32 and 34 respectively. Said first and second side frame members 32 and 34 respectively are provided to guide the vertical movement of the inner, middle and outer step members 40, 50 and 60 respectively between their raised and lowered positions.

A gap reduction apparatus, generally designated 70, comprising a gap reduction member, generally designated 72, having a substantially horizontally disposed stepping surface 73 is disposed within said movable step apparatus 30. In further reference to FIG. 1, said gap reduction member 72 is shown in partially extended third position.

Furthermore, said step members 40, 50 and 60 are shown in a substantially raised position. Stationery commuter platform 22 is located adjacent to door portal aperture 20 and separated by distance 21 from the outer wall surface 12.

In reference to FIG. 2, the first door 16 and second door 18r are shown in their substantially open position enclosed within the door cavity 13. Said gap reduction member 72 is shown in its substantially extended forth position establishing a distance 23 from the commuter platform 22 being approximately 50 inches above the top of rail surface 26.

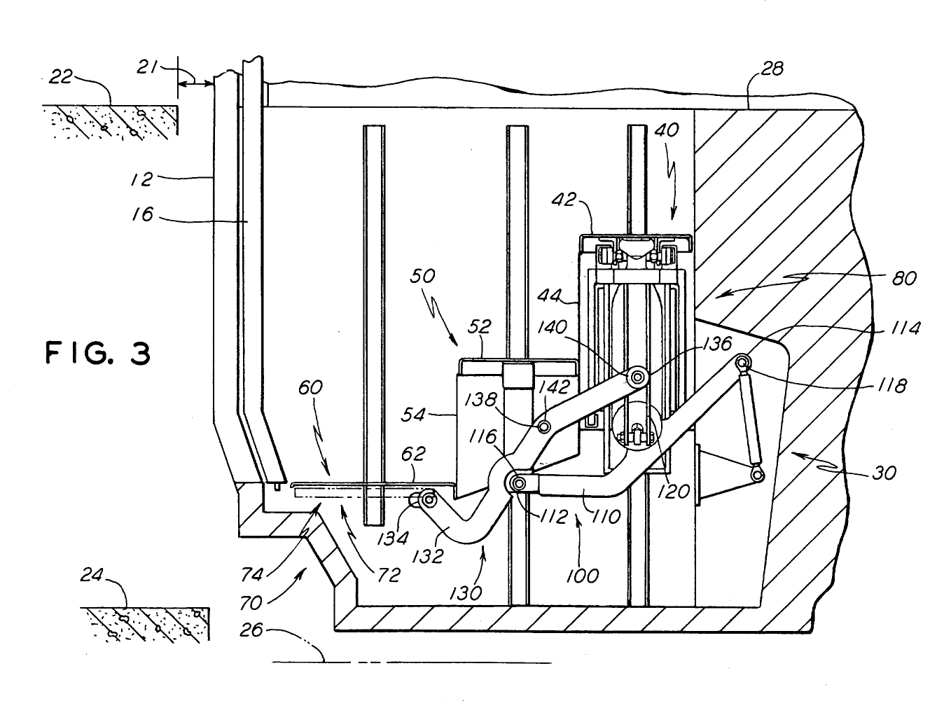

Said movable step apparatus 30 is further shown in its first position being a substantially lowered conventional step configuration in FIG. 3. In this configuration the vertical displacement between inner, middle and outer step members 40, 50 and 60 respectively is approximately 10.5 inches. An upper substantially horizontal stepping surface 42 of the inner step member 40 is positioned at a first elevation with the substantially horizontal stepping surface 52 of the middle step member 50 is positioned at a second lower elevation and with the substantially horizontal stepping surface 62 of the outer step member 60 at a third lower elevation. In this position, a passenger may ingress the vehicle from a street platform 24, being approximately 8 inches above top of rail surface 26, stepping onto the outer step member 40 and further proceeding to the floor surface 28 of the transit vehicle 10. The gap reduction member 72 is shown disposed in a substantially horizontal position under the stepping surface 62.

In this configuration a substantially vertical surface 44 of the inner step member 40 extends vertically past the middle member 50. Similarly, a substantially vertical surface 54 of the middle step member 50 extends vertically past the outer member 60.

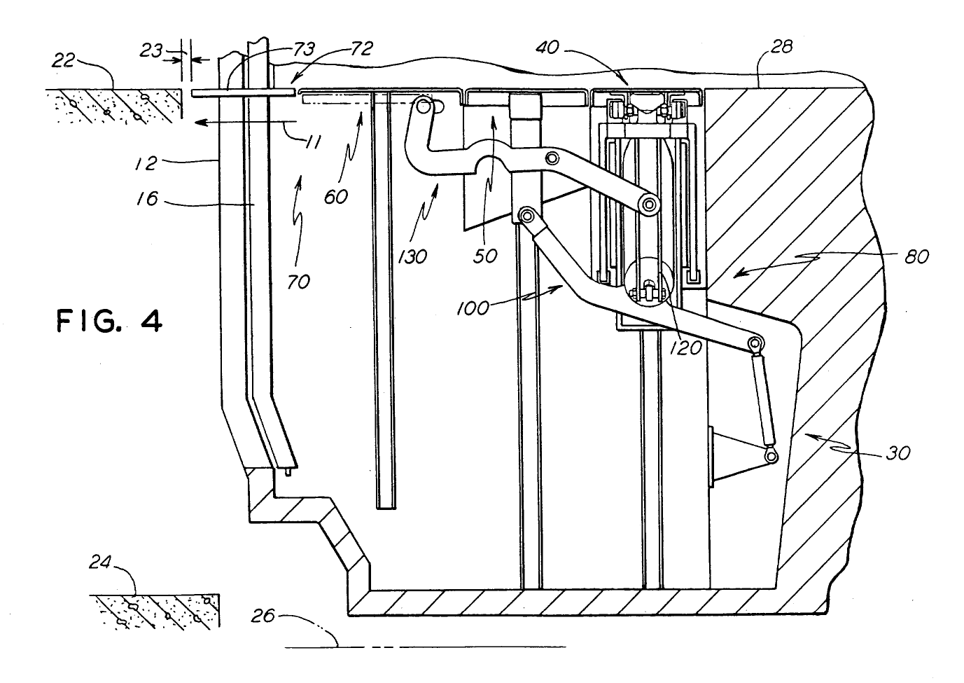

A drive assembly, generally designated 80, enables to raise stepping surfaces 62, 52 and 42 to a second position being a fourth elevation substantially aligned in coplanar relation with the floor surface 28 of the transit vehicle 10, as illustrated in FIG. 4. Gap reduction member 72 is disposed in the substantially horizontal position inside the portal aperture 20 and creating a reduced distance 23 with the commuter platform 22. In this position passengers may egress onto the commuter platform 22 located substantially coplanar with the floor surface 28.

At least one first linkages, generally designated 100, connects the inner step member 40 and middle step member 50 and is responsive to the raising of said inner step member 40 to said second position coplanar with the floor surface 28 to raise the middle step member 50 to said second position while maintaining the upper surfaces 42 and 52 of the step members 40 and 50 respectively in a substantially horizontal position. In the preferred embodiment said at least one first linkage 100 is a plurality of first linkage 100 disposed at each end of the inner step member 40 and middle step member 50.

The first linkage 100 comprises a first linkage arm 110 having first end 112 and second 114. The first end 112 of linkage arm 110 is pivotally connected to the middle step member 50 at pivot portion 116. Pivot means 118 disposed within said linkage arm 110 is provided for mounting the second end 114 of linkage arm 110 to the frame of the vehicle 10 on the opposite side of the inner step member 40. The pivot means 118 permits pivotal movement of the first linkage arm 110 about a pivot point 116 while also providing for reciprocal swinging movement of the pivot point 116 toward and away from the step members 40, 50 and 60. The first linkage 100 further comprises a second linkage arm 120 pivotally connected to the first linkage arm 110 intermediate its ends 112 and 114 and pivotally connected to the inner step member 40.

At least one second linkage, generally designated 130, connects the outer step member 60 to the middle step member 50 and is responsive to the raising of the middle step 50 to raise the outer step member 60 to the fourth elevation coplanar with the floor surface 28. The second linkage 130 comprises a linkage arm 132 pivotably connected to the outer step member 60 at the first end 134 and pivotably connected to the middle step member 50 at the pivot 138 disposed intermediate a first end 134 and a second end 136 having a sliding member 140. In the preferred embodiment sliding member 140 is a roller. In the preferred embodiment said at least one second linkage 130 is a plurality of second linkage 130 disposed at each end of the middle step member 50 and outer step member 60.

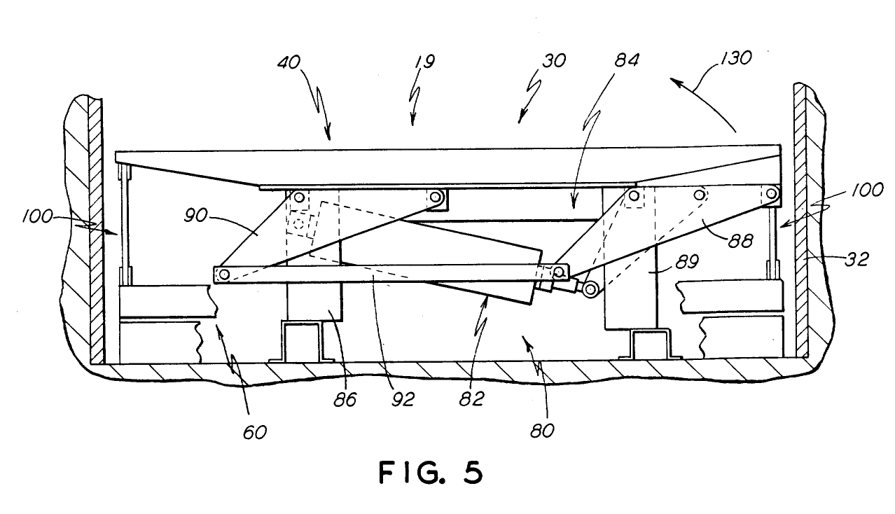

As best shown in FIG. 5, the step drive mechanism, generally designated 80, for raising and lowering the step members 40, 50 and 60 comprises a support assembly, generally designated 84, including a frame member 86 attached to stairwell structure 19, a first lift arm 88 and a second lift arm 90 pivotably connected to said frame member 86 and joined by a brace member 92. A third lift arm 89 is pivotably connected to frame member 86 and substantially connected to first lift arm 88. At least one prime mover 82 is pivotally attached to frame member 86 at one end and pivotally connected to third lift arm 89 at a distal end. In the preferred embodiment said prime mover 82 is a double acting pneumatic cylinder. Alternatively, said prime mover can be a rodless pneumatic cylinder, a hydraulic cylinder or an electric linear drive mechanism.

As may be seen in FIGS. 3 and 4, in sequence, the step members 40, 50 and 60 are, in FIG. 3, in the first position being a conventional step relation to provide ingress onto the floor surface 28 of the vehicle 10 through the stairwell 19 from a street platform 24. In order for the step apparatus 30 to accommodate ingress and egress of passengers from and onto a commuter platform 22, the step members 40, 50 and 60 respectively are raised to the second position substantially coplanar with the floor surface 28, as best shown in FIG. 4.

To accomplish this position shift, the pneumatic system is charged causing third lift arm 89 to rotate in counterclockwise direction 130 and causing said first lift arm 88 and said second lift arm 90 to rotate in the same counter-clock direction 130. The rotation of said lift arms raises step member 40 to the fourth elevation substantially coplanar with the floor surface 28.

The raising of the inner step member 40 in the manner just described to the fourth elevation causes the plurality of first linkage arm 100 to rotate about the pivot 116 raising the middle step member 50 to the fourth elevation substantially coplanar with the floor surface 28. Furthermore, substantially vertical movement of the middle step 50 rotates the link arm 130 about the pivot 142 causing the outer step 60 to rise to the fourth elevation.

The method of reducing the gap between the outer step member 60 and the commuter platform 22 consists of two steps. In the first step, during the vertical movement of the outer step member 60, the gap reduction member 72 disposed underneath the stepping surface 62 is partially driven in the direction 11 by gap reduction drive mechanism, generally designated 74, with said first door 16 and said second door 18 being in a substantially closed position within said portal cavity 20. It can be easily seen that such direction 11 is substantially perpendicular to the movement path of said first door 16 and said second door 18. In the second step, as said first door 16 and said second door 18 reach their respective full open positions said gap reduction drive mechanism 74 further drives gap reduction member 72 in the direction 11 resulting in the substantially reduced distance 23 to the edge of the commuter platform 22 meeting the ADA requirements. The gap reduction drive mechanism 74 can employ a hydraulic or electric prime mover, but preferably employs at least one pneumatic prime mover 76 (not shown).

As has been described herein before, the movable step apparatus 30 and gap reduction apparatus 72 cooperate with a pair of bi-parting first door 16 and second door 18r for at least partially covering and uncovering door portal aperture 20. Those skilled in the art can easily recognized that operation of said movable step apparatus 30 and said gap reduction apparatus 70 will be identical in the case of a single door 16 or 18 for covering and uncovering said door portal aperture 20.

Although a presently preferred and various alternative embodiments of the present invention have been described in considerable detail above with particular reference to the drawing FIGURES, it should be understood that various additional modifications and/or adaptations of the present invention can be made and/or envisioned by those persons skilled in the relevant art without departing from either the spirit of the instant invention or the scope of the appended claims.

What is claimed is:

1. A movable step apparatus comprising:
a) a frame;
b) an inner step member operatively mounted to said frame, said inner step member including a substantially horizontally disposed upper surface;
c) a middle step member operatively mounted to said frame, said middle step member including a substantially horizontally disposed upper surface;
d) an outer step member operatively mounted to said frame, said outer step member including a substantially horizontally disposed upper surface;
e) a drive mechanism operatively associated with said inner, middle and outer step members for varying a vertical position of said inner, middle and outer step members between a first position wherein said inner, middle and outer step members are at different vertical elevations, to a second position wherein said inner, middle and outer step members are substantially coplanar, while maintaining said substantially horizontally disposed upper surfaces of said inner, middle and outer step members respectively in a substantially horizontal plane;
f) at least one first linkage pivotally connecting said inner step member and said middle step member to said frame; and
g) at least one second linkage pivotally connecting said outer step member to said middle step member.

2. A movable step apparatus according to claim 1, wherein said drive mechanism is a pneumatic prime mover.

3. A movable step apparatus according to claim 1, wherein said drive mechanism is an electric prime mover.

4. A movable step apparatus according to claim 1, wherein said drive mechanism is a hydraulic prime mover.

5. A movable step apparatus according to claim 1, wherein said at least one first linkage is a plurality of first linkages disposed at each end of said inner step member and at each end of said middle step member.

6. A movable step apparatus according to claim 1, wherein said at least one second linkage is a plurality of second linkages disposed at each end of said middle step member and at each end of said outer step member.

7. A passenger ingress and egress system disposed within a transit vehicle for accommodating a street platform disposed approximately 8 inches above top of rail and further accommodating a commuter platform disposed approximately 50 inches above the top of rail, said vehicle including a stairwell cavity disposed within a floor surface, said vehicle further including a door portal aperture disposed adjacent said stairwell cavity, said transit vehicle additionally including a door cavity disposed between an outer vehicle wall and an inner vehicle wall, said door cavity further disposed at each end of said door portal aperture, said passenger ingress and egress system comprising:
(a) a first door for at least partially covering and uncovering said door portal aperture, said first door disposed for substantially linear movement within said door portal aperture to its closed position, said first door further disposed for substantially linear movement within said door cavity to its open position;
(b) a second door for at least partially covering and uncovering said door portal aperture, said second door disposed adjacent said first door, said second door disposed for substantially linear movement within said door portal aperture to its closed position, said second door further disposed for substantially linear movement within said door cavity to its open position;
(c) a movable step apparatus disposed within said stairwell cavity, said movable step apparatus for facilitating ingress and egress of passengers to and from said transit vehicle from and onto said street platform, said movable step apparatus further facilitating ingress and egress of passengers to and from said transit vehicle from and onto said commuter platform, said movable step apparatus disposed adjacent said first door, said movable step apparatus further disposed adjacent said second door; and
(d) a gap reduction apparatus disposed within said movable step apparatus for reducing a gap between said commuter platform and said movable step apparatus.

8. A passenger ingress and egress system according to claim 7, wherein said movable step apparatus comprising:
a) a frame;
b) an inner step member operatively mounted to said frame, said inner step member including a substantially horizontally disposed upper surface;
c) a middle step member operatively mounted to said frame, said middle step member including a substantially horizontally disposed upper surface;
d) an outer step member operatively mounted to said frame, said outer step member including a substantially horizontally disposed upper surface;
e) a drive mechanism operatively associated with said inner, middle and outer step members for varying the vertical position of said inner, middle and outer step members between a first position wherein said inner, middle and outer step members are at different vertical elevations to enable ingress and egress of passengers to and from said transit vehicle from and onto said street platform, to a second position wherein said inner, middle and outer step members are substantially coplanar with said floor surface of the transit vehicle to enable ingress and egress of passengers to and from said transit vehicle from and onto said commuter platform, while maintaining said substantially horizontally disposed upper surfaces of said inner, middle and outer step members respectively in a substantially horizontal plane;
f) at least one first linkage pivotally connecting said inner step member and said middle step member to said frame; and
g) at least one second linkage pivotally connecting said outer step member to said middle step member.

9. A passenger ingress and egress system according to claim 8, wherein said drive mechanism is a pneumatic prime mover.

10. A passenger ingress and egress system according to claim 8, wherein said drive mechanism is an electric prime mover.

11. A passenger ingress and egress system according to claim 8, wherein said drive mechanism is a hydraulic prime mover.

12. A passenger ingress and egress system according to claim 8, wherein said at least one first linkage is a plurality of first linkages disposed at each end of said inner step member and at each end of said middle step member.

13. A passenger ingress and egress system according to claim 8, wherein said at least one second linkage is a plurality of second linkages disposed at each end of said middle step member and at each end of said outer step member.

14. A passenger ingress and egress system according to claim 7, wherein said gap reduction apparatus includes:
(a) a gap reduction member having a horizontally disposed stepping surface, said gap reduction member movable in a substantially horizontal plane, said gap reduction member further movable in a direction substantially perpendicular to a linear movement path of said first door, said gap reduction member further movable in a direction substantially perpendicular to a linear movement path of said second door; and
(b) a drive mechanism for moving said gap reduction member in a substantially horizontal plane.

15. A passenger ingress and egress system according to claim 14, wherein drive mechanism is a pneumatic prime mover.

16. A passenger ingress and egress system according to claim 14, wherein drive mechanism is an electric prime mover.

17. A passenger ingress and egress system according to claim 14, wherein drive mechanism is a hydraulic prime mover.

18. A passenger ingress and egress system disposed within a transit vehicle for accommodating a street platform and further accommodating a commuter platform, said vehicle including a stairwell cavity disposed within a floor surface, said vehicle further including a door portal aperture disposed adjacently said stairwell cavity, said transit vehicle additionally including a door cavity disposed between an outer vehicle wall and an inner vehicle wall, said door cavity further disposed at each end of said door portal aperture, said passenger ingress and egress system comprising:
(a) a door for covering and uncovering said aperture, said door disposed for substantially linear movement within said door portal aperture to its closed position, said door further disposed for substantially linear movement within said door cavity to its open position;
(b) a movable step apparatus disposed within said stairwell cavity, said movable step apparatus being for facilitating ingress and egress of passengers to and from said transit vehicle from and onto said street platform, said movable step apparatus facilitating ingress and egress of passengers to and from said transit vehicle from and onto said commuter platform, said movable step apparatus disposed adjacent said door; and
(c) a gap reduction apparatus disposed within said movable step apparatus for reducing a gap between said commuter platform and said movable step apparatus.

19. A passenger ingress and egress system according to claim 18, wherein said movable step apparatus includes:
a) a frame;
b) an inner step member operatively mounted to said frame, said inner step member including a substantially horizontally disposed upper surface;
c) a middle step member operatively mounted to said frame, said middle step member including a substantially horizontally disposed upper surface;
d) an outer step member operatively mounted to said frame, said outer step member including a substantially horizontally disposed upper surface;
e) a drive mechanism operatively associated with said inner, middle and outer step members for varying a vertical position of said inner, middle and outer step members between a first position wherein said inner, middle and outer step members are at different vertical elevations to enable ingress and egress of passengers to and from said transit vehicle from and onto said street platform, to a second position wherein said inner, middle and outer step members are substantially coplanar with said floor surface of said transit vehicle to enable ingress and egress of passengers to and from said transit vehicle from and onto said commuter platform, while maintaining said substantially horizontally disposed upper surfaces of said inner, middle and outer step members respectively in a substantially horizontal plane;
f) at least one first linkage pivotally connecting said inner step member and said middle step member to said frame; and
g) at least one second linkage pivotally connecting said outer step member to said middle step member.

20. A passenger ingress and egress system according to claim 19, wherein said drive mechanism is a pneumatic prime mover.

21. A passenger ingress and egress system according to claim 19, wherein said drive mechanism is an electric prime mover.

22. A passenger ingress and egress system according to claim 19, wherein said drive mechanism is a hydraulic prime mover.

23. A passenger ingress and egress system according to claim 19, wherein said at least one first linkage is a plurality of first linkages disposed at each end of said inner step member and at each end of said middle step member.

24. A passenger ingress and egress system according to claim 19, wherein said at least one second linkage is a plurality of second linkages disposed at each end of said middle step member and at each end of said outer step member.

25. A passenger ingress and egress system according to claim 18, wherein said gap reduction apparatus including:
(a) a gap reduction member having a horizontally disposed stepping surface, said gap reduction member movable in a substantially horizontal plane, said gap reduction member further movable in a direction substantially perpendicular to a linear movement path of said door; and
(b) a drive mechanism for moving said gap reduction member in the substantially horizontal plane.

26. A passenger ingress and egress system according to claim 25, wherein drive mechanism is a pneumatic prime mover.

27. A passenger ingress and egress system according to claim 25, wherein drive mechanism is an electric prime mover.

28. A passenger ingress and egress system according to claim 25, wherein drive mechanism is a hydraulic prime mover.
